(19) United States
(12) Patent Application Publication
(10) Pub. No.: US 2018/0276737 A1
(43) Pub. Date: Sep. 27, 2018

(54) SYSTEM AND METHOD FOR DELAYED TRANSACTION COMPLETION

(71) Applicants: Aparna Krishnan Girish, Foster City, CA (US); Parveen Bansal, Foster City, CA (US)

(72) Inventors: Aparna Krishnan Girish, Foster City, CA (US); Parveen Bansal, Foster City, CA (US)

(21) Appl. No.: 15/465,450

(22) Filed: Mar. 21, 2017

(51) Int. Cl. G06Q 30/06; G06Q 20/24; G06Q 20/36

(52) U.S. Cl. CPC G06Q 30/0633; G06Q 20/367; G06Q 20/24

(57) ABSTRACT

A user's payment preference and other payment information may be linked to a virtual shopping cart to later complete an e-commerce transaction for items stored in a virtual shopping cart. For example, a user may place one or more items in a virtual shopping cart and select a payment method to purchase those items. The user may then be able to select an option to link the selected payment method to the order, but delay completing the purchase by causing a payment payload to be delivered to the merchant without debiting the user's payment account. Later, the user may establish another network session with the merchant. This new session will display the incomplete purchase transaction with both the items and the linked payment method for which the merchant has already received the payment payload. The user may then complete the purchase transaction without having to re-enter payment information.

### FIELD OF TECHNOLOGY

The present disclosure relates to a method and system for delaying completion or payment for an e-commerce transaction.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

E-commerce retail transactions often involve a user selecting a product which causes data corresponding to the product to be saved to a virtual shopping cart into which data for other selected items may be saved. Once the user has included all desired items into their virtual cart, the user may initiate a checkout process. This checkout process typically transmits payment information to the e-commerce merchant. The payment information typically credits the merchant account while it debits the user account.

If the user decides not to complete the checkout process, the e-commerce system may save the data for items the user selected for purchase. The item data may correspond to data for a user account, a browser cookie, or other saving procedure such that, when the user re-visits the e-commerce system, the virtual shopping cart still includes the user's selected items. The user may then complete a transaction to purchase items corresponding to the data saved within the virtual shopping cart. However, if the user had previously entered payment information (e.g., a credit card number or other payment account data), but had not completed the transaction, this payment information is not saved once the user closes the browser or after the current browser session has timed out. This payment information is not saved out of security concerns since personal account numbers and other data linked to a credit card account or other payment method or device are targeted for fraudulent transactions. Thus, when a user revisits an e-commerce website to complete a transaction for items saved within a virtual shopping cart, the user must re-enter payment information to complete the transaction.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, a system or method may link a user's payment preference and other payment information to a virtual shopping cart to later complete an e-commerce transaction for items stored in the virtual shopping cart. For example, a user may place one or more items in a virtual shopping cart and select a payment method to purchase those items. The user may then be able to select an option to link the selected payment method to the order, but delay completing the purchase. This link may deliver a payment payload to the merchant including a Personal Account number (“PAN”) and other data. The user may then close the browser or otherwise end the network session with the merchant e-commerce system. At a later time, the user may establish another session with the merchant e-commerce system. This new session will display the incomplete purchase transaction with both the items and the linked payment method for which the merchant has already received the payment payload. Rather than having to re-enter payment information, the user may be directed to a merchant order confirmation page to complete the transaction.

In some embodiments, a system for linking a payment device to items within a virtual shopping cart for delaying order completion for the items may comprise a payment processing system server, an e-commerce server, and a computing device. The payment processing server may include a processor and a memory storing instructions that, when executed by the processor, create a payment payload from primary account holder data including a personal account number corresponding to a payment device. The e-commerce server may host an e-commerce website for a merchant and include a processor and memory storing instructions. When executed by the processor, the instructions may link items within a virtual shopping cart to the payment payload during a first network session. The computing device may include a processor and a memory storing instructions, as well. When executed by the processor the instructions may complete a purchase transaction for the items using the linked payment payload during a second network session.

In further embodiments, a computer-implemented method may link a payment device to items within a virtual shopping cart to delay order completion for the items. In some embodiments, the method may create a payment payload from primary account holder data during a first network session. The payment payload may include a personal account number corresponding to a payment device. The method may then link the payment payload to a virtual shopping cart hosted by an e-commerce server during the first network session. The method may then complete a purchase transaction for the items using the linked payment payload during a second network session.

### BRIEF DESCRIPTION OF THE DRAWINGS

FIG. 1 illustrates a system for delaying payment for an electronic commerce transaction as described herein;

FIGS. 2A and 2B illustrate different views of an exemplary payment device for use with the system for delaying payment for an electronic commerce transaction as described herein;

FIG. 3 illustrates an exemplary process for delaying payment for an electronic commerce transaction as described herein;

FIG. 4 illustrates an exemplary virtual shopping cart interface;

FIG. 5A illustrates an exemplary payment method interface;

FIG. 5B illustrates an exemplary payment device checkout interface;

FIG. 6 illustrates an exemplary process flow for creating and using a token within the systems and methods described herein;

FIG. 7 illustrates an exemplary delayed order confirmation interface;

FIG. 8 illustrates an exemplary linked shopping cart interface;

FIG. 9 illustrates an exemplary an order confirmation interface; and

FIG. 10 illustrates an exemplary computing device used within the system for linking dynamic information to a payment device transaction record and to implement the various process flows or methods described herein.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

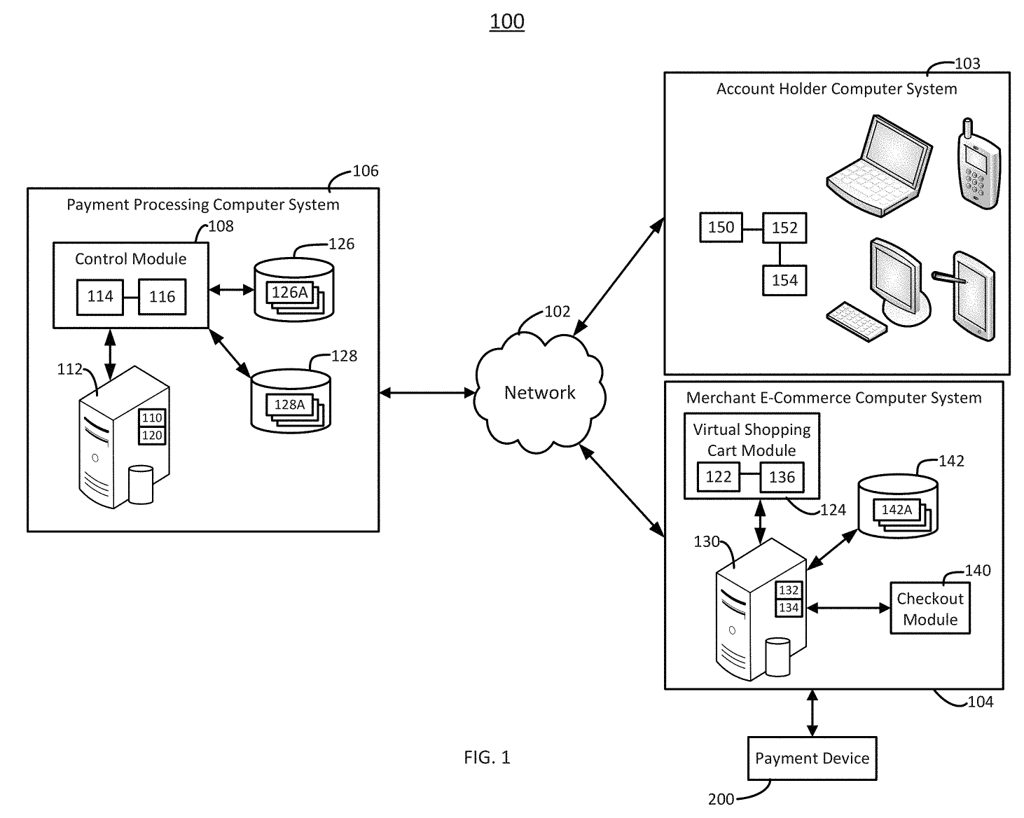

FIG. 1 generally illustrates one embodiment of a system 100 for linking a payment device to items saved to a virtual shopping cart on a merchant's ecommerce system during a first network session to complete the transaction for those items using that saved payment device during a later, second network session. The system 100 may include a computer network 102 that links one or more systems and computer components. In some embodiments, the system 100 includes an account holder computer system 103, a merchant e-commerce computer system 104, a payment processing computer system 106 and a payment device 200. The network 102 may be describes variously as a communication link, computer network, internet connection, etc. The system 100 may include various software or computer-executable instructions stored on tangible memories and specialized hardware components or modules that employ the software and instructions to link a payment payload including a personal account number (“PAN”) or other data to items saved to a virtual shopping cart on a merchant's ecommerce system during a first network session to complete the transaction for those items using that linked payment payload during a later, second network session, as described herein. The various modules may be implemented as computer-readable storage memories containing computer-readable instructions (i.e., software) for execution by one or more processors of the system 100 within a specialized or unique computing device. The modules may perform the various tasks associated with linking a payment method to items stored in a merchant's e-commerce virtual shopping cart, as described herein. The system 100 may also include both hardware and software applications, as well as various data communications channels for communicating data between the various specialized or unique hardware and software components.

The payment processing computer system 106 may include one or more instruction modules including a control module 108 that, generally, may include instructions to cause a processor 110 of a payment processing server 112 to functionally communicate with a plurality of other computer-executable steps or modules, e.g., modules 114 and 116, and components of the system 100 via the network 102. These modules 114, 116 may include instructions that, upon loading into the server memory 120 and execution by one or more computer processors 110, link a payment device 200 or data representing the payment device 200 (i.e., a payment payload 128A) to a virtual shopping cart 122 of a virtual shopping cart module 124 at the merchant e-commerce computer system 104. A first data repository 126 may include primary account holder data 126A that each include various pieces of data to describe an account of a primary account holder and user of the payment processing computer system 106. In some embodiments, primary account holder data 126A or a portion of the primary account holder data 126A may be included with a payment device 200 as the payment payload 128A, as described herein.

A second data repository 128 may include a plurality of payment payloads 128A that include payment information from primary account holder data 126A that may be linked by a linking module 114 to a virtual shopping cart 122. In some embodiments, one of the modules 114, 116 may include a tokenizing module (e.g., tokenizing module 116). The tokenizing module 116 may include instructions to tokenize primary account holder data 126A into a payment payload 128A to be linked by the linking module 114 to the virtual shopping cart 122 and sent to the merchant e-commerce computer system 104 so that a user may delay payment for items placed within the virtual shopping cart 122.

The merchant e-commerce computer system 104 may include any components that are used by a business to complete an internet-based, e-commerce transaction where a customer uses a payment device 200 to link a payment payload 128A to a virtual shopping cart 122 for delayed completion of a purchase transaction for items 136 placed within the virtual shopping cart 122. For example, the system 104 may include an e-commerce server 130 having an e-commerce processor 132 and e-commerce memory 134. The memory 134 may include processor-implemented instructions such as the virtual shopping cart module 124 including the virtual shopping cart 122 and a checkout module 140 that is used by the system 104 to gather a payment payload data 128A, customer account information (e.g., a Personal Account Number (“PAN”) 206A and a Card Verification number (“CVN”) 206B), and customer account data 142A from a customer account data repository 142.

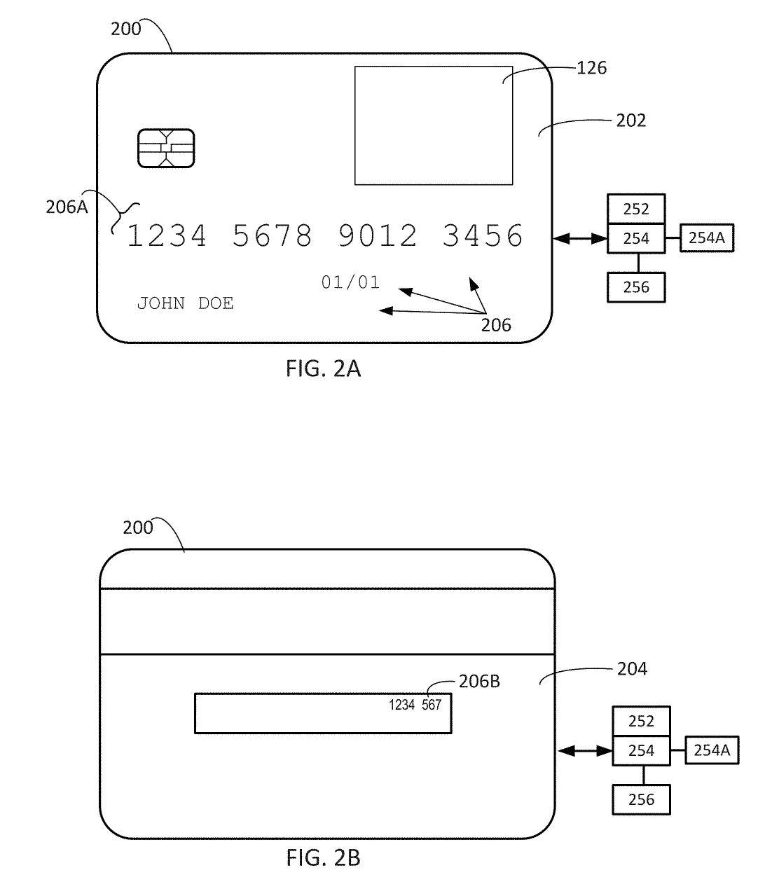

With brief reference to FIGS. 2A and 2B, an exemplary payment device 200 (FIGS. 2A and 2B) may take on a variety of shapes and forms. In some embodiments, the payment device 200 is a traditional card such as a debit card or credit card. In other embodiments, the payment device 200 may be a fob on a key chain, an NFC wearable, or other device. As long as the payment device 200 is able to communicate securely with the payment processing computer system 106 and the merchant e-commerce computer system 104, the form of the payment device 200 may not be especially critical and may be a design choice. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 including the PAN 206A and the CVN 206B. In some embodiments, the payment device 200 may include data corresponding to the primary account holder, such as a primary account holder data 126A for the primary account holder. A memory 254 generally and a module 254A in particular may be encrypted such that all data related to payment is secure from unwanted third parties. A communication interface 256 may include instructions to facilitate sending payment information or a token to identify payment information to the merchant e-commerce computer system 104, which then passes the payment data/token to the payment processing computer system 106 via the network 102.

Returning to FIG. 1, a checkout module 140 of the payment processing server 112 may include various instructions that, upon execution by the processor 132, facilitate employing a payment device 200 for a merchandise transaction with the merchant e-commerce computer system 104. The checkout module 140 may include instructions that, upon loading into the memory 134 of the server 130 and execution by one or more computer processors 132, allow a user to employ the payment device 200 and his or her corresponding customer account data 142A to complete a payment using, for example, the PAN 206A and other data from the payment device that is communicated to the merchant e-commerce computer system 104 via a payment payload 128A (tokenized or untokenized) and also coordinate with the control module 108 to permit interaction with the linking module 114, as described herein. In some embodiments, the checkout module 140 may include instructions to process a payment payload 128A or other transaction data during an in-person or online financial transaction between a primary account holder and a merchant using the payment device 200, the account holder computer system 103, and the merchant e-commerce computer system 104, respectively. For example, the module 140 may include instructions to access one or more of customer account data 142A, primary account holder data 126A, a payment payload 128A, or other data used in the transaction to consummate a delayed purchase transaction, as described herein.

The account holder computer system 103 may be a personal computer, mobile computing device (e.g., mobile phone, tablet, etc.) or other computing device that is capable of accessing the merchant e-commerce computer system 104 via the network 102. The account holder computer system 103 may include a processor 150 and memory 152. The memory 152 may include one or more modules 154 including instructions that, when executed by the processor 150 cause the account holder computer system 103 to access the merchant e-commerce computer system 104 generally and a website hosting the virtual shopping cart module 124, in particular. In some embodiments, the account holder computer system 103 may include one or more modules 154 that facilitate linking a payment payload 128A to the virtual shopping cart 122 including items 136 for purchase in a first session with the merchant e-commerce computer system 104 so that the customer may complete purchase transaction for the items 136 during a second session with the merchant e-commerce computer system 104 without having to re-enter any payment details, as described herein.

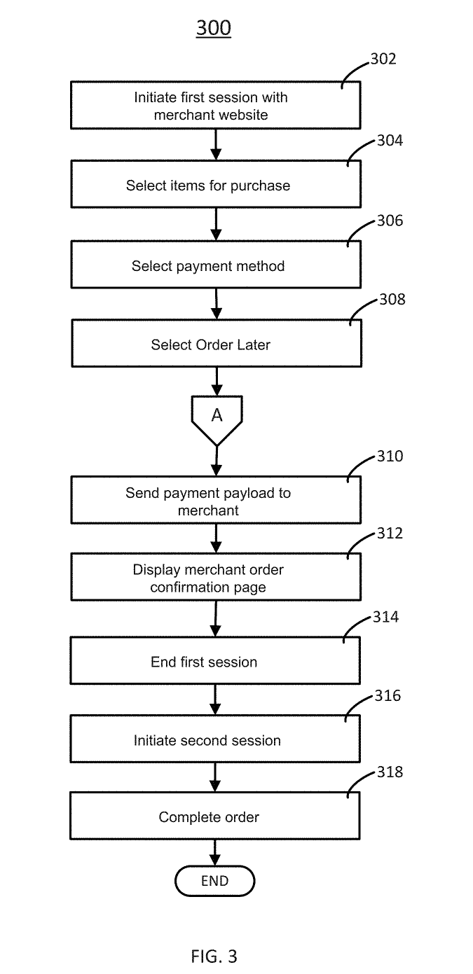

With reference to FIG. 3, a method 300 of linking a payment method to items selected by a consumer via an e-commerce website during a first session at the website in order to complete a purchase transaction for those items during a later, second session at the website. Each step of the method may be performed on a server or other computing device including instructions that, when executed by a processor, perform the action or block described herein.

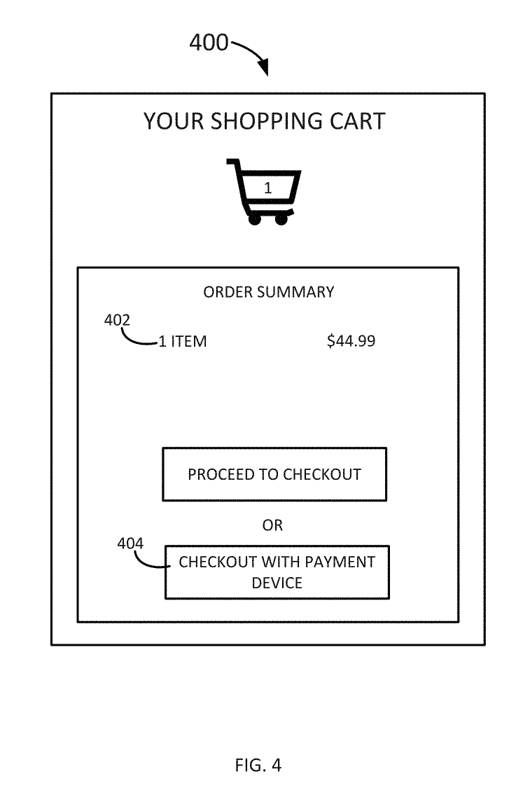

At block 302, the account holder computing system 103 may execute instructions to access the merchant e-commerce computer system 104 via the network 102. For example, the account holder computer system 103 may execute instructions of the module 154 to create a first network session with a shopping cart interface 400 (FIG. 4) of the merchant e-commerce computer system 104. At block 304, the account holder computing system 103 may execute instructions to cause the e-commerce server to store items 136 (FIG. 1) within the virtual shopping cart 122 using the virtual shopping cart module 124 of the merchant e-commerce computer system 104.

The virtual shopping cart interface 400 may include an indication 402 corresponding to products or services selected by a user via the shopping cart interface 400. These indications 402 may correspond to items 136 selected by a user of the account holder computer system 103 and stored by the merchant e-commerce computer system 104 within the virtual shopping cart 122 of the virtual shopping cart module 124. The interface may also include a payment method button 404.

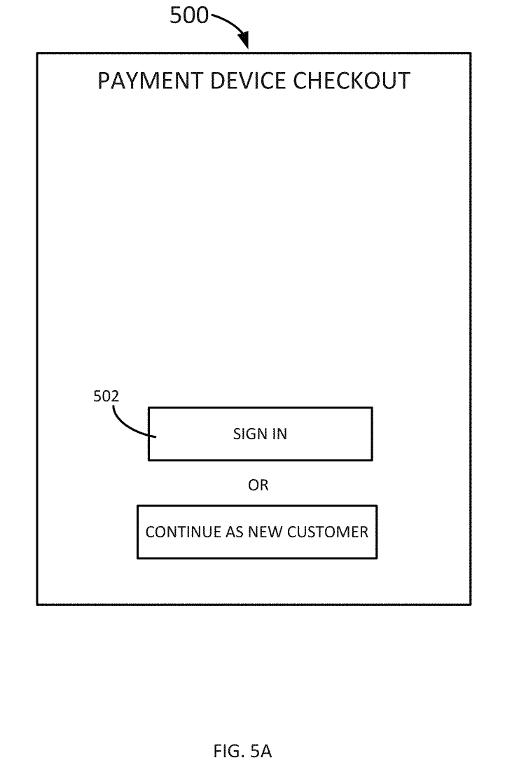

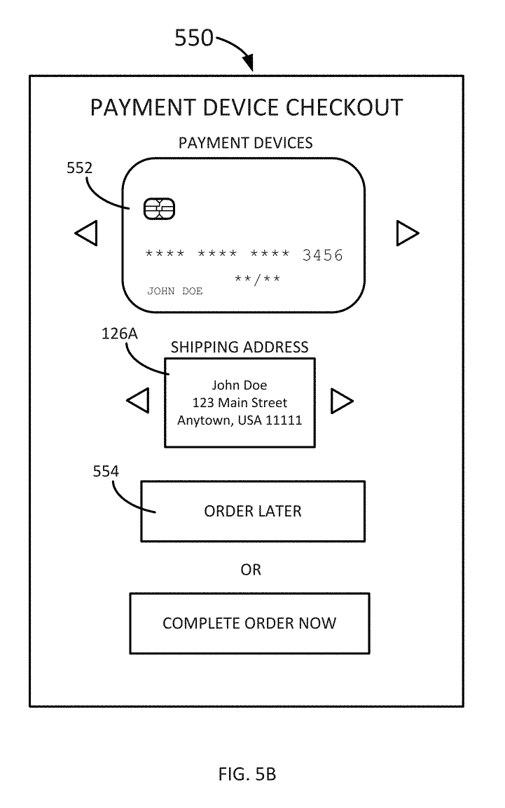

At block 306, the account holder computer system 103 may execute instructions to select a payment method via the payment method button 404 within the interface 400. In some embodiments, selecting the payment method button 404 may cause the merchant e-commerce computer system 104 to instantiate a payment method interface 500 (FIG. 5A). In some embodiments, instantiating the payment method interface 500 may begin a network session between the account holder computer system 103 and the payment processing computer system 106. The account holder computer system 103 may further execute instructions to provide login credentials to the payment processing system server 112 via selection of a sign in button 502 within the payment method interface 500. The method 300 may provide the sign in credentials to the payment processing computer system 106.

Upon sign in, the system 100 may launch a payment device checkout interface 550 (FIG. 5B) within a browser of the account holder computer system 103. The payment device checkout interface 550 may include graphic representations of one or more payment devices 552, primary account holder data 126A (e.g., a shipping address) or other data corresponding to a payment device 200 and the representations of one or more payment devices 552 displayed within the interface 550.

At block 308, the system 100 may execute instructions to link a payment device 200 to a purchase transaction for the items 136. In some embodiments, in response to selection of an Order Later button graphic object 554 within the interface 550, the method 300 may tokenize some or all of the primary account holder data 126A corresponding to a payment device 200 that was selected for the transaction at block 306.

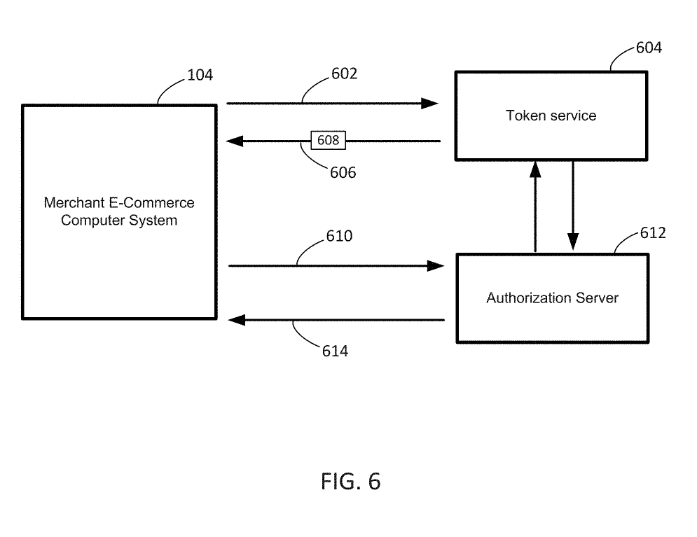

With reference to FIG. 6, in some embodiments, the primary account holder data may be converted into a token that represents a personal account number and/or other primary account holder data 126A for use in the purchase transaction between the account holder computer system 103 and the merchant e-commerce computer system 104. FIG. 6 may illustrate at a high level how tokens may operate to provide payment information to the merchant e-commerce computer system 104. In a first step, the virtual shopping cart module 124 or other module of the merchant e-commerce computer system 104 may execute instructions to issue a request 602 to a token service 604 to receive payment data for a consumer. In a next step, a token service 604 (e.g., the tokenizing module 116) of the payment processing computer system 106 may generate a response 606 that includes a token 608. The token 608 may take the place of a personal account number (PAN) or other primary account holder data 126A of the user. The token 608 may be able to be converted by the token service 604 into the PAN, but no other entity could perform the same conversion. The merchant e-commerce computer system 104 may request via communication 610 authorization on behalf of the customer to an authorization server 612 (i.e., a module of the payment processing server 112) using the received token 608 as the payload. The authorization server 612 may request confirmation of the token 608 via communication with the token service 604 and provide an authorization response 614. The token 608 alone may be useless, but the token service 604 may translate the token 608 into a PAN while the PAN may not be exposed over a network.

Returning to FIG. 3, at block 310, the payment processing computer system 106 may send a payment payload 128A including the token 608 to the merchant e-commerce computer system 104. In some embodiments, the linking module 114 may execute instructions to link the payload 128A including the token 608 to a virtual shopping cart 122 and/or one or more items 136 stored by the virtual shopping cart module 124. When the linking module 114 executes instructions to link the payload 128A the virtual shopping cart 122, items 136 within the virtual shopping cart 122 may be edited or exchanged for other items. In further embodiments, the virtual shopping cart 122, items 136, payload 128A and token 608 may also be linked to customer account data 142A.

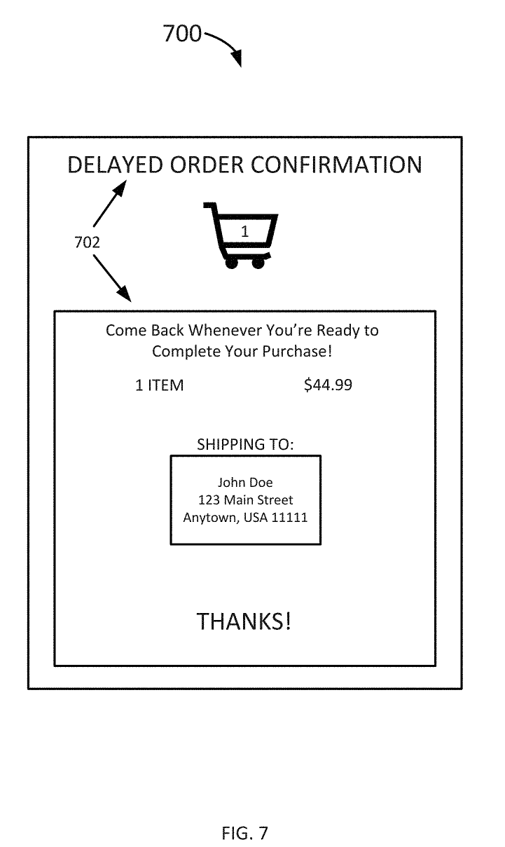

At block 312, the method 300 may execute instructions to display a delayed order confirmation interface 700 (FIG. 7) at the account holder computer system 103 upon receipt of the payload 128A and token 608 at the merchant e-commerce computer system 104. The delayed order confirmation webpage 600 may include one or more indications 702 that the payment payload 128A, token 608 or other data was received by the merchant e-commerce computer system 104 as well as shipping or other primary account holder data 126A or customer account data 142A.

At block 314, the account holder computer system 103 may end its first network session with the merchant e-commerce computer system 104. In some embodiments, the module 154 of the account holder computer system 103 may include instructions to redirect or close a browser executing on the account holder computer system 103. The first network session may indicate that the order later functions described here were completed and the merchant e-commerce computer system 104 received the payload 128A and/or token 608.

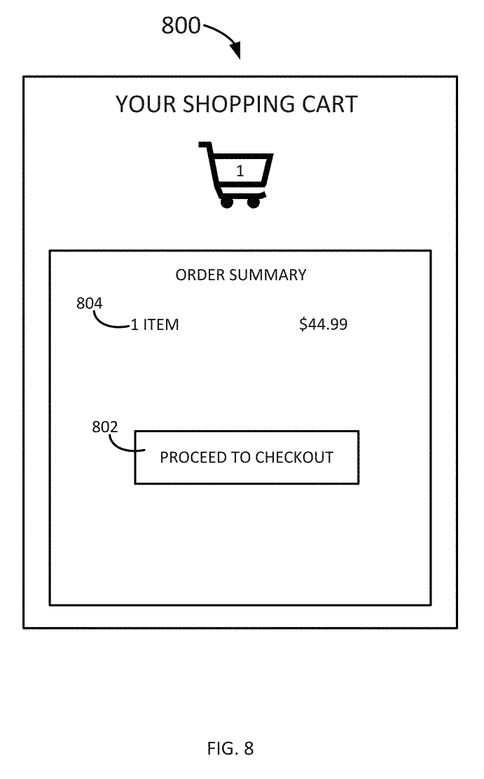

At block 316, with reference to FIG. 8, the account holder computer system 103 may initiate a second network session with the merchant e-commerce computer system 104. In some embodiments, the account holder computer system 103 may initiate the second network session with a linked shopping cart interface 800 (FIG. 8) at the merchant e-commerce computer system 104. The linked shopping cart interface 800 may include a checkout button graphic object 802 to complete a purchase transaction for an item 804 using the payment payload 128A and token 608.

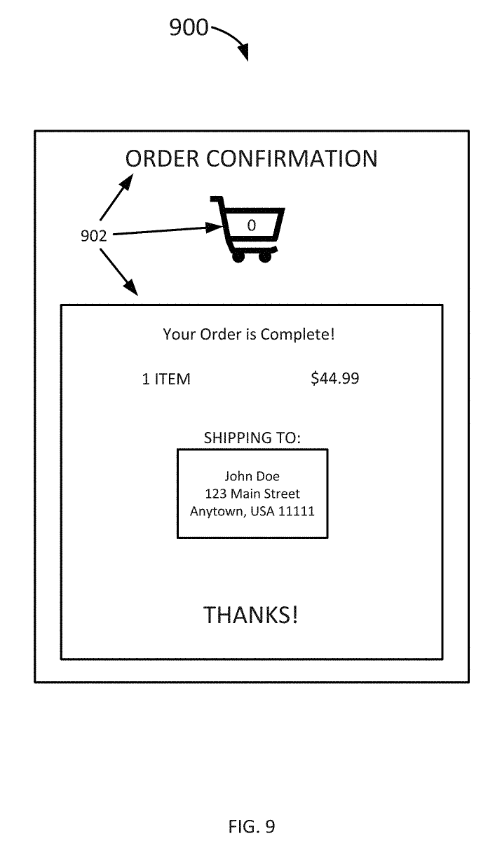

At block 318, upon selection of the checkout button graphic object 802, the method 300 may execute instructions to display an order confirmation interface 900 (FIG. 9). The order confirmation webpage may include indications that the order is complete (e.g., an indication that the virtual shopping cart 122 no longer includes any items 136, etc.) using the payment payload data 128A and token 608 and the method 300 may end.

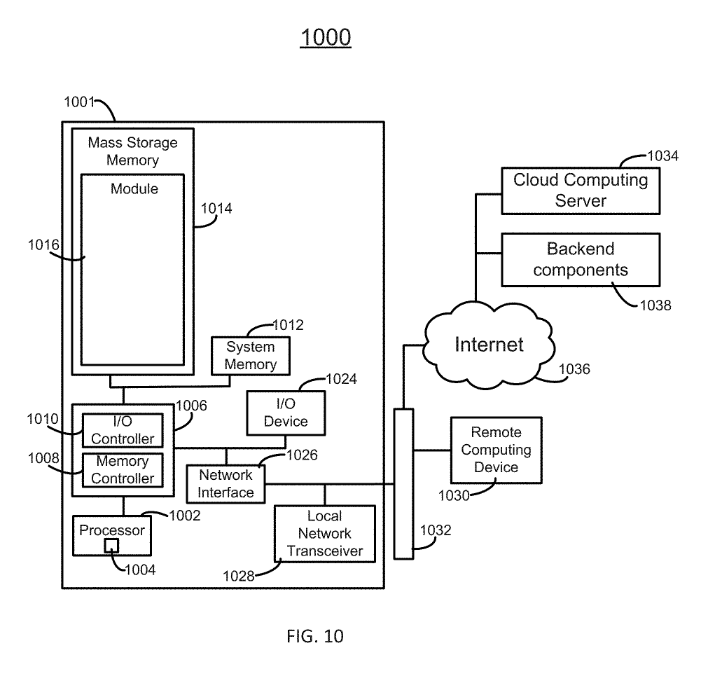

FIG. 10 is a high-level block diagram of an example computing environment 1000 for the system 100 and method 300 for linking a payment device to items saved to a virtual shopping cart on a merchant's ecommerce system during a first network session to complete the transaction for those items using that saved payment device during a later, second network session. The computing device 1001 may include a server (e.g., the payment processing server 112, e-commerce server 130), a mobile computing device (e.g., account holder computer system 103, a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems of FIG. 1 and methods of FIG. 3. Although the example system 1000 is described below as including a plurality of peripherals, interfaces, chips, memories, etc., one or more of those elements may be omitted from other example processor systems used to implement and execute the example systems and methods. Also, other components may be added.

As shown in FIG. 10, the computing device 1001 includes a processor 1002 that is coupled to an interconnection bus. The processor 1002 includes a register set or register space 1004, which is depicted in FIG. 10 as being entirely on-chip, but which could alternatively be located entirely or partially off-chip and directly coupled to the processor 1002 via dedicated electrical connections and/or via the interconnection bus. The processor 1002 may be any suitable processor, processing unit or microprocessor. Although not shown in FIG. 10, the computing device 1001 may be a multi-processor device and, thus, may include one or more additional processors that are identical or similar to the processor 1002 and that are communicatively coupled to the interconnection bus.

The processor 1002 of FIG. 10 is coupled to a chipset 1006, which includes a memory controller 1008 and a peripheral input/output (I/O) controller 1010. As is well known, a chipset typically provides I/O and memory management functions as well as a plurality of general purpose and/or special purpose registers, timers, etc. that are accessible or used by one or more processors coupled to the chipset 1006. The memory controller 1008 performs functions that enable the processor 1002 (or processors if there are multiple processors) to access a system memory 1012 and a mass storage memory 1014, that may include either or both of an in-memory cache (e.g., a cache within the memory 1012) or an on-disk cache (e.g., a cache within the mass storage memory 1014).

The system memory 1012 may include any desired type of volatile and/or non-volatile memory such as, for example, static random access memory (SRAM), dynamic random access memory (DRAM), flash memory, read-only memory (ROM), etc. The mass storage memory 1014 may include any desired type of mass storage device. For example, the computing device 1001 may be used to implement a module 1016 (e.g., the various modules as herein described). The mass storage memory 1014 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 1001, the system 100, and method 300. Thus, a module, block, function, operation, procedure, routine, step, and method can be implemented in hardware, firmware, and/or software. In one embodiment, program modules and routines are stored in mass storage memory 1014, loaded into system memory 1012, and executed by a processor 1002 or can be provided from computer program products that are stored in tangible computer-readable storage mediums (e.g. RAM, hard disk, optical/magnetic media, etc.).

The peripheral I/O controller 1010 performs functions that enable the processor 1002 to communicate with a peripheral input/output (I/O) device 1024, a network interface 1026, a local network transceiver 1028, (via the network interface 1026) via a peripheral I/O bus. The I/O device 1024 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 1024 may be used with the module 1016, etc., to receive data from the transceiver 1028, send the data to the components of the system 100, and perform any operations related to the methods as described herein. The local network transceiver 1028 may include support for a Wi-Fi network, Bluetooth, Infrared, cellular, or other wireless data transmission protocols. In other embodiments, one element may simultaneously support each of the various wireless protocols employed by the computing device 1001. For example, a software-defined radio may be able to support multiple protocols via downloadable instructions. In operation, the computing device 1001 may be able to periodically poll for visible wireless network transmitters (both cellular and local network) on a periodic basis. Such polling may be possible even while normal wireless traffic is being supported on the computing device 1001. The network interface 1026 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 1008 and the I/O controller 1010 are depicted in FIG. 10 as separate functional blocks within the chipset 1006, the functions performed by these blocks may be integrated within a single integrated circuit or may be implemented using two or more separate integrated circuits. The computing environment 1000 may also implement the module 1016 on a remote computing device 1030. The remote computing device 1030 may communicate with the computing device 1001 over an Ethernet link 1032. In some embodiments, the module 1016 may be retrieved by the computing device 1001 from a cloud computing server 1034 via the Internet 1036. When using the cloud computing server 1034, the retrieved module 1016 may be programmatically linked with the computing device 1001. The module 1016 may be a collection of various software platforms including artificial intelligence software and document creation software or may also be a Java® applet executing within a Java® Virtual Machine (JVM) environment resident in the computing device 1001 or the remote computing device 1030. The module 1016 may also be a “plug-in” adapted to execute in a web-browser located on the computing devices 1001 and 1030. In some embodiments, the module 1016 may communicate with back end components 1038 via the Internet 1036.

The system 1000 may include but is not limited to any combination of a LAN, a MAN, a WAN, a mobile, a wired or wireless network, a private network, or a virtual private network. Moreover, while only one remote computing device 1030 is illustrated in FIG. 10 to simplify and clarify the description, it is understood that any number of client computers are supported and can be in communication within the system 1000.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A system for linking a payment device to items within a virtual shopping cart to delay order completion for the items comprising:
a payment processing system server including a processor and a memory storing instructions that, when executed by the processor:
create a payment payload from primary account holder data during a first network session, the payment payload including a personal account number corresponding to a payment device, and
link the payment payload to a virtual shopping cart;
an e-commerce server hosting an e-commerce website including the virtual shopping cart for a merchant, the e-commerce server including a processor and memory storing instructions that, when executed by the processor, receive the payment payload corresponding to items within the virtual shopping cart during the first network session; and
a computing device including a processor and a memory storing instructions that, when executed by the processor, complete a purchase transaction for the items using the linked payment payload during a second network session.

2. The system of claim 1, wherein the payment processing system server includes a tokenizing module stored in the memory and including instructions that, when executed by the processor, tokenize the personal account number such that the personal account number is only readable by a token service.

3. The system of claim 1, wherein the memory of the payment processing system server stores further instructions that, when executed by the processor, link the payment payload to one or more of the virtual shopping cart or the items within the virtual shopping cart.

4. The system of claim 1, wherein the memory of the computing device stores further instructions that, when executed by the processor, create the first network session between the computing device and the e-commerce server.

5. The system of claim 1, wherein the memory of the payment processing system server stores further instructions that, when executed by the processor, launch a payment device checkout interface within a browser of the computing device in response to receiving login credentials from the computing device.

6. The system of claim 5, wherein the payment device checkout interface includes a first graphic object.

7. The system of claim 6, wherein, in response to selection of the first graphic object, the processor of the payment processing system server executes the instructions to tokenize the personal account number such that the personal account number is only readable by a token service.

8. The system of claim 5, wherein the memory of the e-commerce server includes further instructions that, when executed by the processor of the e-commerce server, causes the browser to display a linked shopping cart interface during the second network session.

9. The system of claim 8, wherein the linked shopping cart interface includes a second graphic object and, in response to selection of the second graphic object, the processor of the e-commerce server executes further instructions stored in the memory to display an order confirmation webpage in the browser, the order confirmation webpage including an indication that an order for the items is complete.

10. The system of claim 1, wherein, in response to receiving the payment payload, the processor of the e-commerce server executes instructions to launch a delayed order confirmation webpage including an indication that the e-commerce server received the payment payload.

11. A computer-implemented method for linking a payment device to items within a virtual shopping cart to delay order completion for the items comprising:
creating a payment payload from primary account holder data during a first network session, the payment payload including a personal account number corresponding to a payment device;
linking the payment payload to a virtual shopping cart hosted by an e-commerce server during the first network session; and
completing a purchase transaction for the items using the linked payment payload during a second network session.

12. The method of claim 11, further comprising tokenizing the personal account number such that the personal account number is only readable by a token service.

13. The method of claim 11, further comprising linking the payment payload to the items within the virtual shopping cart.

14. The method of claim 11, further comprising creating the first network session between a computing device and an e-commerce server.

15. The method of claim 11, further comprising launching a payment device checkout interface within a browser of a computing device in response to receiving login credentials from a computing device.

16. The method of claim 15, wherein the payment device checkout interface includes a first graphic object.

17. The method of claim 16, further comprising to tokenizing the personal account number in response to selection of the first graphic object, wherein the personal account number is only readable by a token service.

18. The method of claim 15, further comprising displaying a linked shopping cart interface during the second network session.

19. The method of claim 18, wherein the linked shopping cart interface includes a second graphic object and, in response to selection of the second graphic object, displaying an order confirmation webpage in the browser, the order confirmation webpage including an indication that an order for the items is complete.

20. The method of claim 11, wherein, in response to receiving the payment payload, launching a delayed order confirmation webpage including an indication that the e-commerce server received the payment payload.
